(19) United States
(12) Patent Application Publication
(10) Pub. No.: US 2024/0032490 A1
(43) Pub. Date: Feb. 1, 2024

(54) IRRIGATION SYSTEMS AND METHODS WITH SATELLITE COMMUNICATIONS

(71) Applicant: Rain Bird Corporation, Azusa, CA (US)

(72) Inventors: Randy R. Montgomery, Tucson, AZ (US); Leo M. Pedlow, JR., Vail, AZ (US)

(21) Appl. No.: 18/227,846

(22) Filed: Jul. 28, 2023

Related U.S. Application Data
(60) Provisional application No. 63/393,789, filed on Jul. 29, 2022.

(51) Int. Cl. A01G 25/02; A01G 25/16

(52) U.S. Cl. CPC A01G 25/02; A01G 25/162

(57) ABSTRACT

In some embodiments, devices, systems, and methods are provided herein useful to control the communication between irrigation system components. In some embodiments, an irrigation system comprises an irrigation system component comprising or connected to a satellite transceiver configured to transmit communications to one or more irrigation control devices and/or receive communications from the one or more irrigation control devices via one or more communication satellites, wherein the irrigation system component comprises at least one of a water emitter, a valve actuator, a valve, a decoder, a pump, a power control device, and a sensor.

### CROSS-REFERENCE TO RELATED APPLICATION(S)

This application claims the benefit of U.S. Provisional Application No. 63/393,789 filed Jul. 29, 2022 (Docket No. 8473-155366-US), which is incorporated herein by reference in its entirety.

### TECHNICAL FIELD

The present invention is generally related to irrigation and, more particularly, to irrigation systems and methods capable of satellite communication.

### BACKGROUND

Irrigation systems generally include a control device used to control the delivery of water with irrigation devices. To control the delivery of water to the property, a control device of the system needs to communicate with or send signals to other devices such as watering devices, irrigation valves, controllers, sensors, and so on. Wires may be used to connect the control device with other devices. Wiring can be expensive and difficult to install especially when the distances are great. In some installations, controllers and devices in the system may be connected wirelessly, e.g., using point to point wireless links and/or local area and/or wide area terrestrial wireless networks, such as WiFi, cellular networks.

### BRIEF DESCRIPTION OF THE DRAWINGS

Disclosed herein are embodiments of systems, apparatuses and methods pertaining to irrigation systems using satellite communications. This description includes drawings, wherein:

FIGS. 1A-1C illustrate various irrigation systems using satellite communications in some embodiments.

FIGS. 2A-2D illustrate exemplary parameter control units for use irrigation systems, such as those shows in FIGS. 1A-1C in some embodiments.

FIGS. 3A-3D illustrate various irrigation system components with one or more transceivers in some embodiments.

FIGS. 4A-4C illustrate various irrigation system components with one or more power sources in some embodiments.

FIGS. 5A-5G illustrate various user interfaces (UI) of an irrigation control application displayed on a mobile electronic device in some embodiments.

FIGS. 6-10 illustrate flow diagrams of various processes for use in various irrigation systems in some embodiments.

FIG. 11 illustrates an exemplary distributed control irrigation system using satellite communications in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. The scope of the invention should be determined with reference to the claims. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the present invention. Thus, appearances of the phrases “in one embodiment,” “in an embodiment,” “in some embodiments”, “in some implementations”, and similar language throughout this specification may, but do not necessarily, all refer to the same embodiment.

In some embodiments, an irrigation system comprises an irrigation system component comprising or connected to a satellite transceiver configured to transmit communications to one or more irrigation control devices and/or receive communications from one or more irrigation control devices via one or more communication satellites, wherein the irrigation system component comprises at least one of a water emitter, a valve actuator, a valve, a decoder, a pump, a power control device, and a sensor.

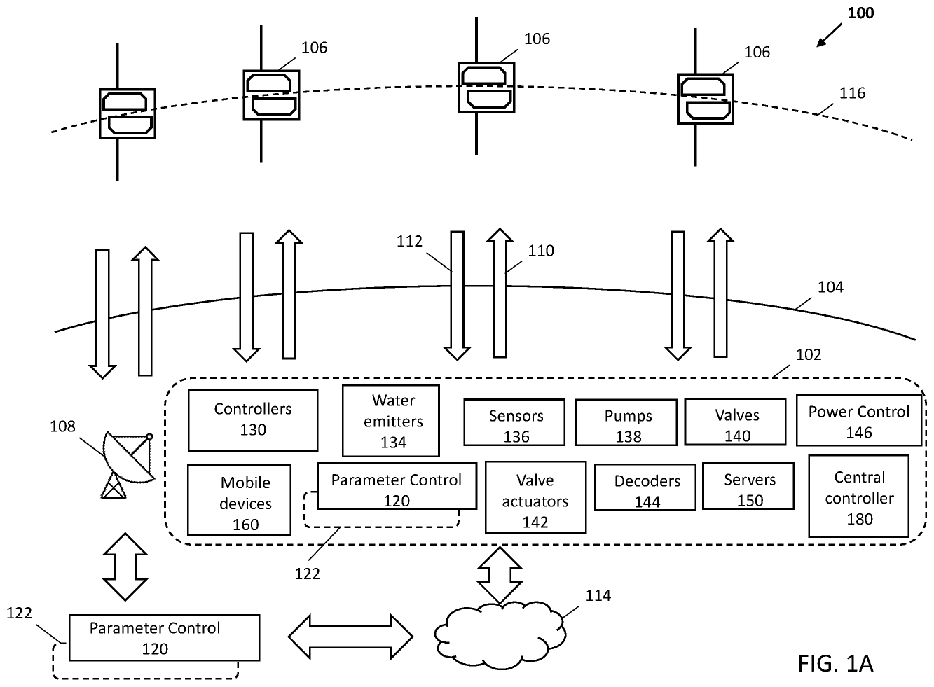

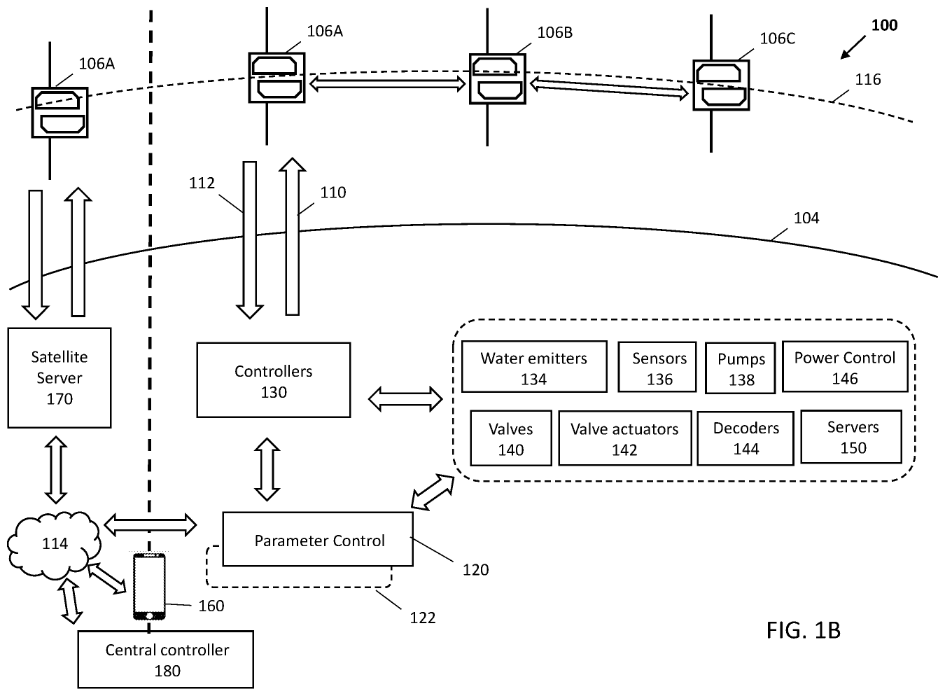

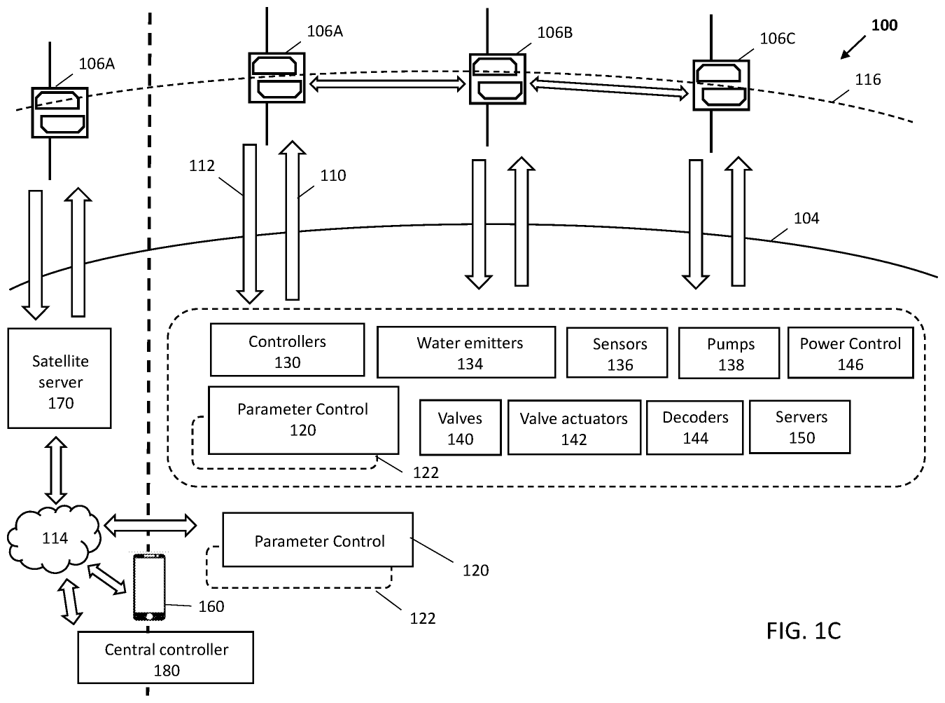

Referring to FIG. 1A, an irrigation system 100 is illustrated that uses satellite communications. On, above, near or below ground irrigation system components 102 are shown at a terrestrial surface 104. Although, communication satellites 106 are shown in orbit 116 in FIG. 1A-1C, the communication satellites 106 may not be limited to orbiting communication satellites. For example, the communication satellites may be, but not limited to, low earth orbit (LEO) satellites, medium earth orbit (MEO) satellites, geostationary orbit (GEO) satellites, Sun-synchronous orbit (SSO) satellites, and/or geostationary transfer orbit (GTO) satellites. The satellites 106 may communicate with gateways 108 (or relay stations, etc.), as well as with one or more of the irrigation system components 102. Illustrated are satellite uplinks 110 and satellite downlinks 112. Further, in some embodiments, the gateways 108 and one or more of the irrigation components 102 may alternatively or additionally communicate via terrestrial-based networks such as network 114.

The satellites 106 can be any known or future satellite and can communicate using any known or future communication protocol, power, and band. In some embodiments, the satellites 106 are small satellites, such as those developed by SpaceX (e.g., Swarm Technologies system), or any other public, private, or government agency, for example.

The network 114 may be any known or future wide-area network (WAN), a local area network (LAN), a personal area network (PAN), a wireless local area network (WLAN), Wi-Fi, Zigbee, Bluetooth (e.g. Bluetooth Classic, Bluetooth Low Energy (BLE) networks) LoRa, LoRaWAN, cellular data networks, or any other public or private internet or intranet network, or combinations of such networks.

Generally, communication between various electronic devices of system 100 may take place over hard-wired, wireless, cellular, Wi-Fi or Bluetooth networked components or the like. In some embodiments, one or more electronic devices/components of system 100 may be realized using cloud-based, physically hosted infrastructure or any combination thereof and the physical infrastructure may be on-premises, remotely hosted or any combination thereof.

Irrigation system components 102 may include various irrigation control devices and field devices. The irrigation control devices are generally devices that control the operation of other irrigation components and devices and may include a central irrigation controller 180, servers 150, one or more irrigation controllers 130 such as computer controllers, computers with control software, dedicated controllers, handheld controllers, and mobile electronic devices 160 with control software (irrigation control applications or apps), by way of example. In some embodiments, the irrigation controller 130 may operate in accordance with a schedule such as an irrigation schedule, a lighting schedule, resource distribution and/or use schedule. For example, according to a schedule, the irrigation controller 130 may send signals, messages, and communications to the field devices to implement the schedule. The central irrigation controller 180 may provide control of irrigation over the irrigation system 100. In some embodiments, irrigation schedules can be created at one or more of the irrigation control devices. For example, irrigation schedules can be created at the central irrigation controller 180, the irrigation controller 130, and/or the mobile electronic device 160 having an irrigation control application installed thereon. In some embodiments, the central controller 180 can send any schedules to the controllers 130, where the controllers store and execute the schedules. In other embodiments, the central controller 180 executes the schedule and send commands to the irrigation controllers to implement. In either case, the irrigation controllers 130 operate in accordance with one or more schedules.

Field devices may include water emitters 134, sensors 136 (e.g., temperature, soil moisture/salinity/pH, wind speed, humidity, solar radiation/intensity, rain, rain drop, flow, pressure), pumps 138, valves 140 (master, station), valve actuators 142, decoders 144, and power control device 146 (e.g., electrical relay, electrical contactor, MOSFET, SCR, triac, switch, transistor, or other type of power controlling, directing or switching device) integrated or coupled to other field devices, by way of example. The water emitters 134 may include rotors, sprinklers, drip emitters, by way of example. The field devices may also include lights, dimmers, and so on. It is understood that there are examples of irrigation system related components and other or future systems could include additional or different components.

In some embodiments, each of the irrigation system components may be a component with one of functions of the water emitter, the valve actuator, the valve, the decoder, the pump, the electrical relay or power control, and the sensor, or a component with any one or more functions of or any combination of functions of the water emitter, the valve actuator, the valve, the decoder, the pump, the power control, and the sensor.

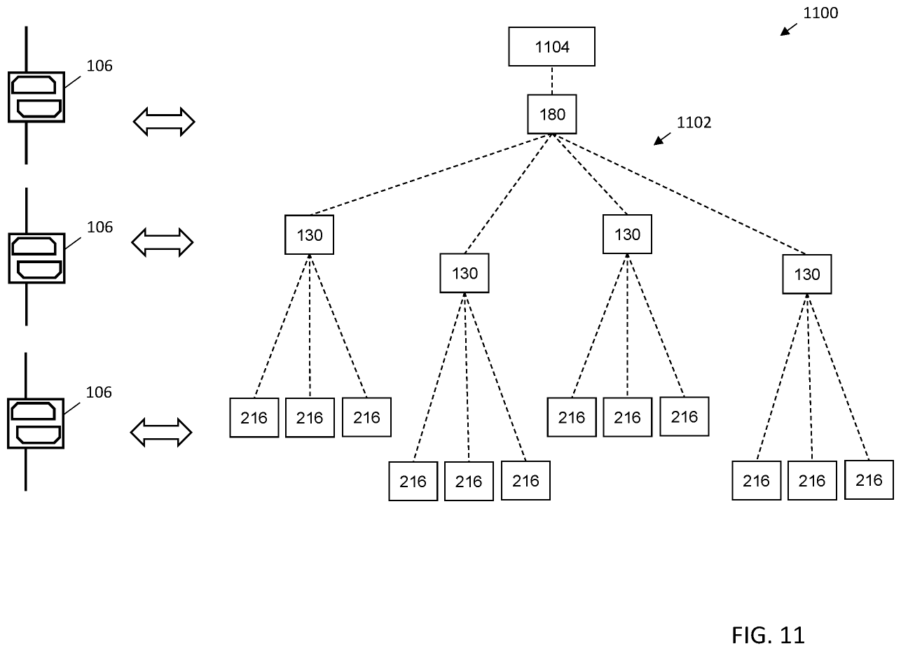

In some embodiments, multiple irrigation control devices are interconnected in a hierarchy to distribute the multiple field devices across the multiple irrigation control devices. In some embodiments, the multiple irrigation control devices are interconnected in a hierarchy to distribute the water emitters 134, sensors 136, pumps 138, valves 140, valve actuators 142, decoders 144, and controls 146 of the irrigation system across the multiple irrigation control devices under a top level irrigation control device or for redundancy and fault tolerance. Each of the interconnected irrigation control devices may communicate using the satellite communications and/or the terrestrial based communications including wireless, direct wireline, and fiber communications. See FIG. 11, for an example hierarchy system.

Communications and controls between various irrigation system components can happen in any number of ways as is known in the art. Devices may be wired (above, at or below ground) and/or wirelessly connected. Examples of common irrigation control systems and devices are described in the following documents: US Publication No. 2009/0099701 to Li et al. published Apr. 16, 2009; U.S. Pat. No. 11,109,546 to Weiler et al. issued Sep. 7, 2021 (Docket 144302); U.S. Pat. No. 11,089,746 to Montgomery et al. issued Aug. 17, 2021 (Docket 148484); U.S. Pat. No. 10,863,682 to Ensworth et al. issued Dec. 15, 2020 (Docket 144300); U.S. Pat. No. 10,772,267 to Tennyson et al. issued Sep. 15, 2020 (Docket 144341); U.S. Pat. No. 10,732,320 to Hem et al. issued Aug. 4, 2020 (Docket 145756); U.S. Pat. No. 11,119,513 to Weiler et al. issued Sep. 14, 2021 (Docket 147703); U.S. Pat. No. 11,064,664 to Ersavas et al. issued Jul. 20, 2021 (Docket 149502); U.S. Pat. No. 10,999,983 to Walker et al. issued May 11, 2021 (Docket 148758), all of which are incorporated herein by reference.

In some embodiments, one or more of the irrigation system components are network addressable and can be referred to as Internet of Things (IoT) devices.

The use of communication satellites 106 which communicate with one or more of the irrigation system components 102 allows there to be ground-to-space and space-to-ground communications including of the irrigation system components 102.

In some embodiments, one or more of the irrigation system components 102 transmit communications to the communication satellites 106 and/or receive communications from communication satellites 106. Various combinations of irrigation system components may communicate using communication satellites 106. In some embodiments, one or more irrigation system components 102, each of which comprises at least one of an irrigation control device, a water emitter 134, a valve actuator 142, a valve 140, a decoder 144, a pump 138, and a sensor 136 may transmit communications to and/or receive communication from one or more communication satellites 106. In some embodiments, one or more irrigation system components 102, each of which comprises at least one of an irrigation controller 130 operating in accordance with a schedule, a water emitter 134, a valve actuator 142, a valve 140, a decoder 144, a pump 138, a power control device 146, and a sensor 136, a server 150 can transmit communications to and/or receive communication from one or more communication satellites.

In some embodiments, an irrigation system component 102 comprising at least one of the water emitter 134, the valve actuator 142, the valve 140, the decoder 144, the pump 138, the power control device 146, and the sensor 136 may transmit communications to one or more irrigation control devices and/or receive communications from the one or more irrigation control devices via communication satellites 106. In these embodiments, the one or more irrigation control devices may also communicate with the communication satellites 106. For example, one or more irrigation system components 102, each comprising at least one of the water emitter 134, the valve actuator 142, the valve 140, the decoder 144, the pump 138, the power control device 146, and the sensor 136, may transmit communications to and/or receive communications from the irrigation control device such as the irrigation controller 130, the central irrigation controller 180, and the server 150 via the communication satellites 106 and the irrigation control device may transmit communication to the one or more irrigation system components 102 and/or receive communication from the one or more irrigation system components 102 via the communication satellites 106.

In some embodiments, the sensor 136 may communicate with the communication satellites 106 and the sensor 136 may share/transmit, via the communication satellites, sensor data to the irrigation control devices of the system 100 in which the sensor 136 is included and/or irrigation control devices of other irrigation systems used by other users. In these embodiments, the irrigation control devices of the system 100 and/or the irrigation control device of another irrigation system can adjust a schedule based on the shared sensor data. In some embodiments, the sensor may share/transmit the sensor data to the other irrigation system such as field devices that adjust their operation based on the shared sensor data.

In some embodiments, one or more irrigation control device may transmit communications to communication satellites and/or receive communications from one or more communication satellites, and other irrigation system components may transmit communications to the irrigation control device and/or receive communications from the irrigation control device via terrestrial-based networks 114.

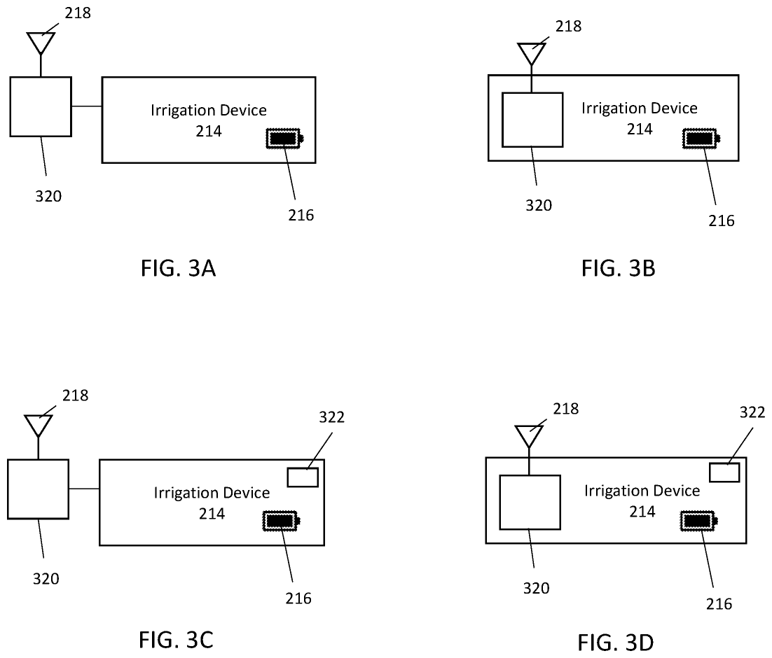

Any irrigation system component 102 that communicates via communication satellites 106 may comprise or be coupled to a suitable satellite transceiver and antenna. For example, as shown in FIG. 3A, an irrigation device 214 may be coupled or connected to a satellite transceiver 320 and a satellite antenna 218. Referring to FIG. 3B, the irrigation device 214 may comprise satellite transceiver 320 and the satellite antenna 218 as part of the device. In this disclosure, the irrigation device 214 may generally represent one of the irrigation system components.

In some embodiments, the irrigation system components 102 that can communicate using satellite communications and alternatively and/or additionally may further communicate using terrestrial communications such as the terrestrial network 114 such that the irrigation system components 102 may communicate using satellite communications and/or terrestrial communications. Any of the irrigation system components 102 that can communicate using terrestrial communications may comprise a terrestrial transceiver. For example, referring to FIG. 3C, the irrigation device 214 coupled or connected to a satellite transceiver 320 and a satellite antenna 218 may further comprise a terrestrial transceiver 322 and suitable antenna or interface (not shown). Referring to FIG. 3D, in some embodiments, the irrigation device 214 comprising a satellite transceiver 320 and a satellite antenna 218 may further comprise a terrestrial transceiver 322 and suitable antenna or interface (not shown). The terrestrial transceiver 322 may be a wireless and/or wired transceiver with suitable antenna or interface, such as wireline connection or port.

In some embodiments, the irrigation system components configured to communicate using satellite communications and one or more alternative communications (e.g., terrestrial communications) that exclude satellite communications. In these embodiments, the satellite communications may be the primary communication method for the irrigation system components, and generally, the terrestrial transceiver is in a low power or no-power (dormant) state. However, when the system detects a trigger condition, the irrigation system components may communicate using one of the one or more alternative communications. The trigger condition may include any one of following conditions:
communications via a satellite link are unavailable;
the communications attempted to transmit via the satellite link are unsuccessful in excess of a predetermined period or number of attempts; and
a malfunction or fault is detected in the satellite transceiver.

For example, the system 100 may automatically redirect the communications, which has been attempted to transmit via satellite communications but has not been transmitted, via one of the one or more alternative communications in the event that the trigger condition is detected.

Before redirecting the communications, when there are two or more alternative communications available, the one or more irrigation control device may select one alternative communications for redirection from the two or more alternative communications available at the time of selection. The selection may be based on a ranking of the two or more alternative communications available at the time of selection and the ranking may be based on at least one of cost, reliability, data transmission rate, power consumption, and autonomy of the alternative communications.

In some embodiments, when the one or more irrigation control devices are configured to communicate with the one or more communication satellites 106, but the trigger condition is detected, the one or more irrigation control devices may operate in accordance with a default schedule stored in memory of the irrigation control devices. The irrigation control devices may generate and/or update a schedule based on communications received from other irrigation system components. But when the irrigation control device can not properly receive, from other irrigation system components, communications that are necessary to generate and/or update the schedule, the irrigation control devices may operate in accordance with the default schedule. In some embodiments, the default schedule may be provided by a contractor and/or predetermined by users.

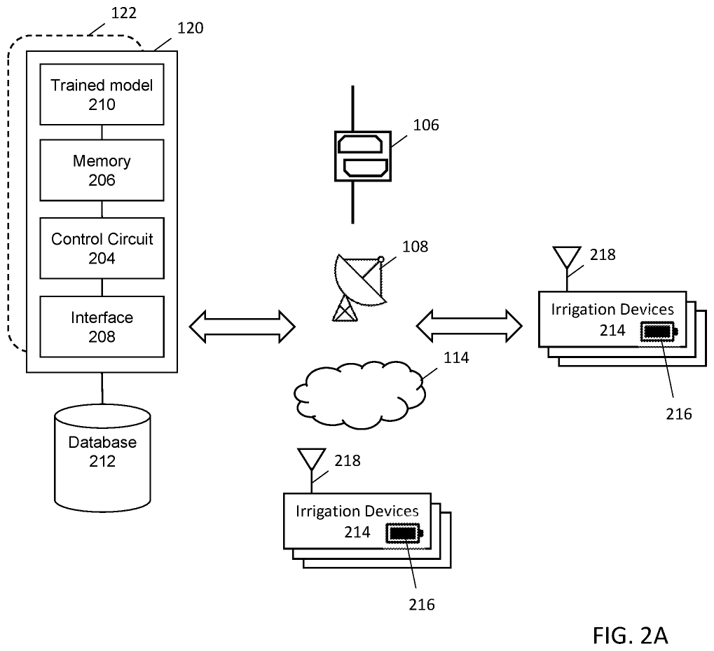

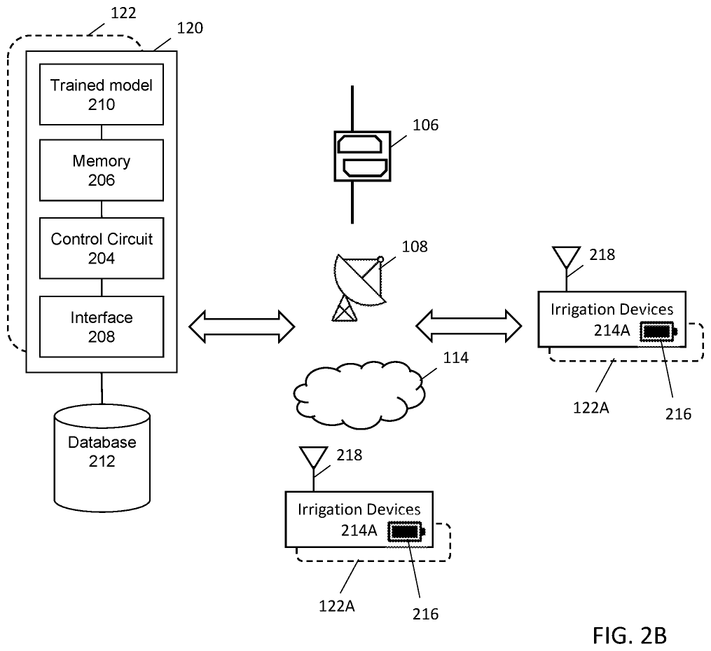

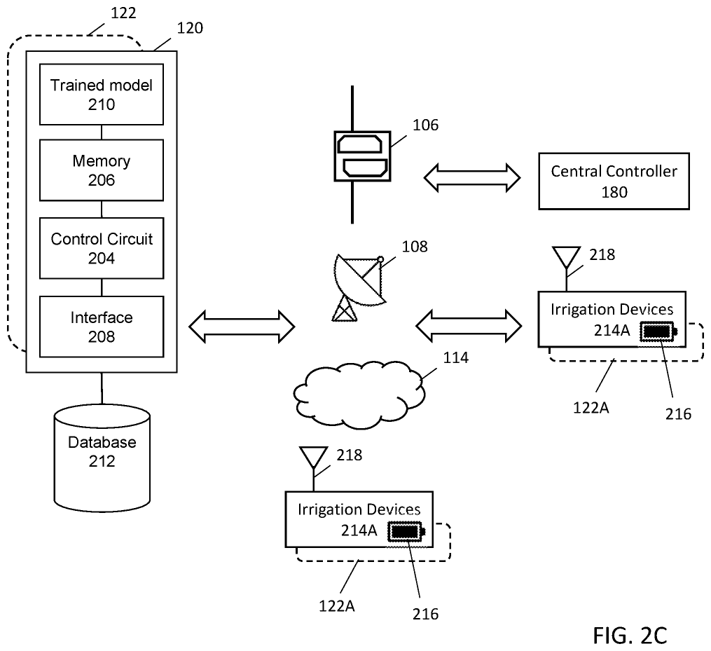

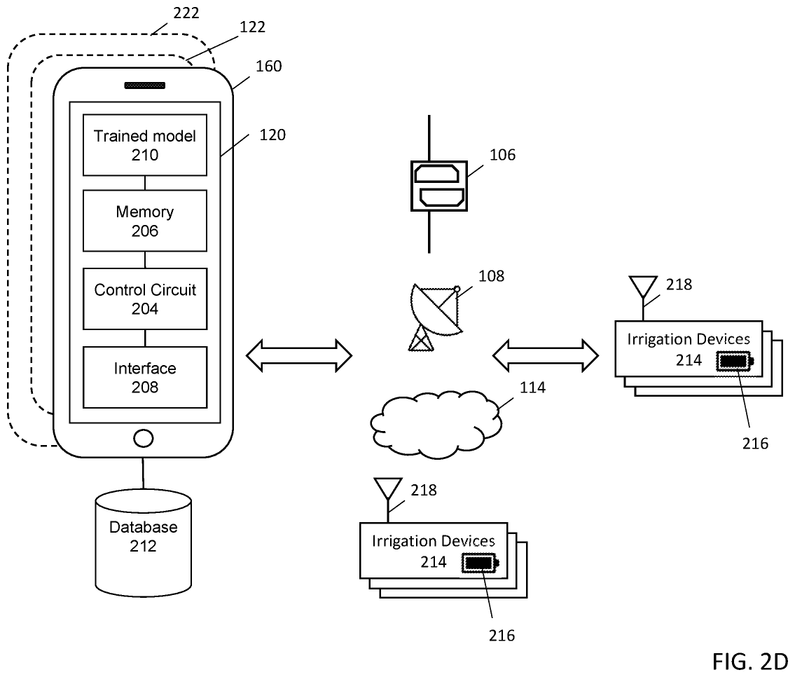

In some embodiments, some of the irrigation system components 102 are battery powered. For example, some irrigation system components 102 are not located to receive dedicated and continuous power, or to easily receive continuous power via a wireline connection. In such cases, the irrigation system components 102 may include a power source (such as a battery 216, see FIG. 2A). The power source may be a single use battery and needs to be replaced once depleted. The power source may be a rechargeable battery.

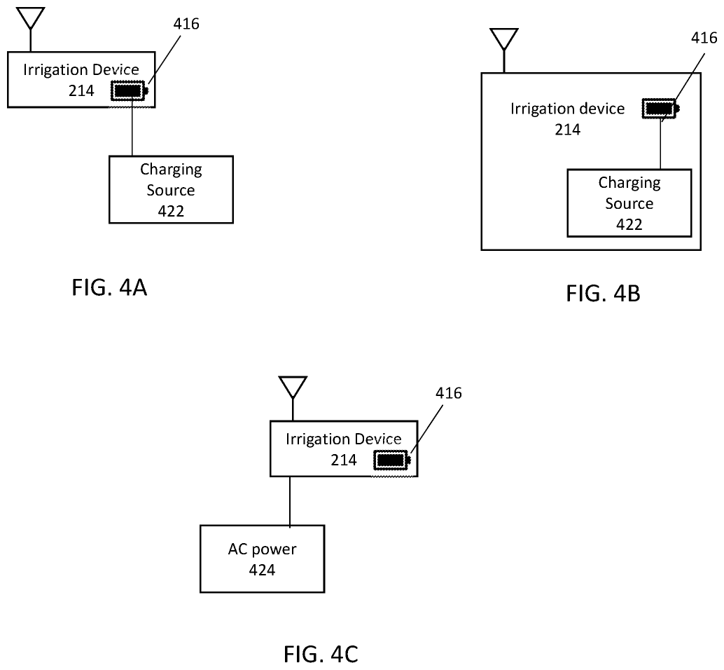

In some embodiments, one or more irrigation system components 102 that can communicate using the communication satellites 106 may comprise a battery 216 and are battery powered. Referring to FIGS. 4A-4B, the irrigation device 214 comprising a rechargeable battery 416, and the rechargeable battery may be connected to a charging source 422. As shown in FIG. 4A, in some embodiments, the rechargeable battery 416 of the irrigation device 214 may be connected to a charging source 422 disposed outside the irrigation device 214. In some embodiments, as shown in FIG. 4B, the irrigation device 214 comprising a rechargeable battery 416 may further comprise the charging source 422 of the device 214 connected to the rechargeable battery 416. The charging source 422 may include, but not limited to, a battery charging generator such as a solar cell, a solar panel, and/or a motion responsive mechanism (e.g., power is generated by flowing water in the system using a turbine system). For example, the motion responsive mechanism may be a hydro-electric power generation module that converts hydro energy of a water flow to electrical energy. It is advantageous to apply a charging source to the battery power to the irrigation system components 102 that can communicate using satellite communications may be advantageous because this combination of battery power and the satellite communication may lengthen the battery life or at least allow the system 100 to anticipate the expected battery life.

In some embodiments, alternating current (AC) power is not supplied to the battery powered irrigation system components 102. In some other embodiments, AC power may be supplied to the irrigation system components that include a battery and are battery powered. Referring to FIG. 4C, AC power 424 may be applied to the irrigation device 214 that comprises a rechargeable battery 416. In the embodiment of FIG. 4C, the AC power 424 may be a primary power source and the irrigation device 214 does not use the battery power when sufficient AC power 424 is provided to the irrigation device 214. The irrigation device 214 may use the power of battery 416 when the AC power 424 supplied to the irrigation device 214 is not sufficient to operate the irrigation device 214. The transition from the AC power to the battery power may be automatically conducted when the irrigation device determines that the AC power 424 currently supplied is not sufficient. Once the AC power supply has been restored and become sufficient, the irrigation device 214 automatically stops using battery power and only uses the AC power 424. In some embodiments, the charging state of the rechargeable battery may be automatically maintained by the irrigation device 214 and the irrigation device 214 may use the AC power 424 to charge the rechargeable battery 416.

Battery life is a potential concern in any system relying on battery powered devices. Thus, system designers and developers need to consider the communication needs and power usage of the devices in their operational use to consider battery size, chemistry, and expected life. And as is well known, the frequency of communication (messaging, polling, wake/sleep cycles), length/size of messages, communication frequency/power, satellite constellation, etc. affect battery life. Additionally, line of sight obstructions, interference sources, and whether a component is above or below grade can impact battery life.

Referring back to FIG. 1A, in such a system including irrigation system components using wireless communications (e.g., satellite communications) and relying on battery power, some embodiments provide a parameter control unit 120 having a parameter control application 122. The parameter control unit 120 controls communication parameters of the irrigation system components.

In some embodiments, the parameter control unit 120 may include a satellite transceiver 320 and satellite antenna 218 such that the parameter control unit 120 may communicate with communication satellites 106. In some embodiments, the parameter control unit 120 may include a terrestrial transceiver 322 for terrestrial communications with the gateways 108 and/or terrestrial based networks 114. In some embodiments, the parameter control unit 120 may include a satellite transceiver 320 and a terrestrial transceiver 322 such that the parameter control unit 120 may communicate using either the satellite communication or the terrestrial communications.

Referring now to FIG. 1B, the irrigation controller 130 operating in accordance with a schedule may include or be connected to a satellite transceiver 320 and a satellite antenna 218 such that the irrigation controller 130 may directly communicate with one or more communication satellites 160A, 160B, 160C. In describing communication satellites, the communication satellites 106A, 106B, 106C may be collectively referred to with a reference numeral 106 unless it is necessary to distinguish them. In the embodiment of FIG. 1B, at least one of the water emitter 134, the sensor 136, the pump 138, the valve 140, the valve actuator 142, the decoder 144, the power control 146, and the server 150 include terrestrial communication transceivers configured to transmit communications to the irrigation controller 130 and/or receive communications from the irrigation controller 130 via terrestrial communications. In the embodiment of FIG. 1B, the irrigation system components transmitting communications to the irrigation controller 130 and/or receiving communications from the irrigation controller 130 via the terrestrial communications may not include a satellite transceiver and a satellite antenna and, therefore, may be configured not to communicate with communication satellites 106.

In some embodiments, parameter control unit 120 may communicate with other irrigation system components, such as the irrigation controller 130, the water emitter 134, the sensor 136, the pump 138, the valve 140, the valve actuator 142, the decoder 144, the power control device 146, and the server 150, via terrestrial communications.

In some embodiments, the irrigation system 100 may further include a satellite server 170. The satellite server 170 may communicate with terrestrial-based networks 114 and may also communicate with the communication satellites 106. In some embodiments, any irrigation system components comprising a satellite transceiver 320 and a satellite antenna 218 may transmit communications to the satellites server 170 and/or receive communications from the satellite server 170 via one or more communication satellites 106.

In some embodiments, the satellite server 170 is part of the satellite system including the satellites 106. For example, in the Swarm Technologies system developed by SpaceX, a Hive server equates to the satellite server 170. Users wanting to use the satellites need to provision the devices to communicate with the satellite server 170. The satellite server 170 maintains a registry of the devices so if a user would like to send a message to a given irrigation controller 130 or other component 102, the user provisions the controller 130 or component 102 with the satellite server 170 so that the satellite server knows the location and address of the given controller 130 or component 102 and then can upload the message to the satellite 106 to then download the message to the given controller 130 or component 102 when in range. On the other hand, if the controller 130 or component 102 intends to send a message or communication to another device, that controller 130 or component 102 uploads the message to a satellite 106 which can be directly downloaded to the other device or downloaded back to the satellite server 170. The satellite server 170 is configured to know where to route any received messages, e.g., route to a given central controller 180, mobile electronic device 160, parameter control 120 via the network 114.

In some embodiments, one or more irrigation system components that can communicate with the communication satellites 106 may transmit, via the terrestrial network, communications to the satellite server 170 and the satellite server 170 may transmit the received communications to communication satellites 106. Then, the satellites 106 may transmit the communications to the irrigation system components that are able to receive the communications from the communication satellites 106. In some embodiments, before transmitting the received communication to the communication satellites 106, the satellite server 170 may store the received communication in the memory of the satellite server 170.

Further, in some embodiments, irrigation system components that are not able to communicate with the communication satellites 106 may receive communications from irrigation system components that can transmit communications only to the communication satellite via the satellite server 170. For example, irrigation system components comprising a satellite transceiver 320 and a satellite antenna 218 may transmit communications to the communication satellites 106 and the communication satellites 106 may transmit the received communication to the satellite server 170, and the satellite server 170 may transmit, via terrestrial networks 114, the received communications to the irrigation system components that cannot communicate with the communication satellites 106.

In some embodiments, the irrigation controller 130 having a satellite transceiver 320 and a satellite antenna 218 transmit communications to the satellite server 170 and/or receive communications from the satellite server 170 via one or more communication satellites. In some embodiments, the irrigation control device that does not have a satellite transceiver (e.g., the central irrigation controller 180 and/or the mobile electronic device 160 having an irrigation control application installed thereon) may communicate, via terrestrial networks 114, with a satellite server 170 to deliver, via the satellite server 170 and the communication satellites 106, messages to the irrigation controllers 130.

In some embodiments, the communication satellites 106A, 106B, 106C can communicate with one another. In some embodiments, the one or more communication satellites comprise communication satellites that are configured for satellite-to-satellite communications. Although FIGS. 1B and 1C illustrate only three communication satellites 106A, 106B, 106C, the number of the communication satellites is not limited. The irrigation system may include less than three or more than three communication satellites.

In some embodiments, referring to FIG. 1C, one or more irrigation system components, each of which comprises at least one of the irrigation controller 130, the water emitter 134, the sensor 136, the pump 138, the parameter control unit 120, the valve 140, the valve actuator 142, the decoder 144, the power control device 146, and the server 150, can each directly transmit communications to the communication satellites 106 and/or each directly receive communications from the communication satellites 106. For example, the mobile electronic device 160 having the irrigation an irrigation control application installed thereon and/or the central irrigation controller 180 may transmit communications to the satellite server 170 via the terrestrial network 114 and the satellites server 170 may transmit the communication received from the mobile electronic device 160 and/or the central irrigation controller 180 to the one or more irrigation system components comprising at least one of the irrigation controller 130, the water emitter 134, the sensor 136, the pump 138, the parameter control unit 120, the valve 140, the valve actuator 142, the decoder 144, the power control device 146, and the server 150 using the communication satellites 106. Similarly, the one or more irrigation system components comprising at least one of the irrigation controller 130, the water emitter 134, the sensor 136, the pump 138, the parameter control unit 120, the valve 140, the valve actuator 142, the decoder 144, the power control device 146, and the server 150 may transmit communications to the satellites server 170 via the communication satellites 106, and the satellite server 170 may transmit, via the terrestrial networks 114, the received communications to the mobile electronic device 160 with an irrigation control application installed thereon and/or the central controller 180.

Referring to FIGS. 1A-1C, various system communication architectures are described. At a high level, FIG. 1A provides an overview of the many possible communication options in which one or more of the various irrigation components 102 may have satellite transceivers to communicate with satellites 106, and/or may have wired/wireless terrestrial transceivers to communicate outside of the local system via network 114. FIG. 1A also shows variations of the location of parameter control units 120. The embodiments of FIG. 1B generally show a hub and spoke communication system in which one or more components (e.g., controllers 130) have satellite transceivers to communicate with satellites 106 and acts as a hub, relaying communications to the other system components that lack satellite transceivers. FIG. 1B further shows the satellite server 170 as a routing device that manages communicates between devices intending to use the satellite. For example, devices are provisioned with the satellite server 170, and the satellite server 170 maintains a mapping of devices to route communications. FIG. 1B also shows satellite-to-satellite communications although in some embodiments, the satellites 106 do not communicate with each other. FIG. 1B also shows that various devices can communicate with the satellite server 170 to communicate with devices in the field. And FIG. 1C is similar to FIG. 1B but illustrates a direct to device communication model in which one or more of the irrigation components have satellite transceivers to communicate directly with satellites 106 and do not require a terrestrial hub as in FIG. 1B.

In some embodiments, the use of satellites 106 by irrigation components 102 in the irrigation system provides for an alternative to traditional terrestrial networks, such as cellular communications. In some embodiments, it is desired to avoid the setup cost and subscription fees to maintain terrestrial communications. And in some embodiments, irrigation components are in remote locations without access to reliable terrestrial networks. In some embodiments, the need for high traffic, real-time communications are not important and low latency, periodic communications are acceptable for the application. In some cases, it may only be necessary to communicate once per day/week and such needs often don't justify the expense of traditional terrestrial networks. And in some embodiments, reliable AC power is not available at all irrigation components such that battery power is useful or needed. In some embodiments, battery power can be conserved when used with satellite communications where communications can be as regular as intended, and be varied such as described herein. It is believed that in some embodiments, satellite transceivers in certain irrigation components are a departure from known systems, and where particular irrigation components are battery powered.

FIGS. 2A-2C illustrate various embodiments of the parameter control unit 120 and communication paths between the parameter control unit 120 and other irrigation system components 102.

Referring to FIGS. 2A-2C, the parameter control unit 120 may comprise a control circuit 204, a memory 206 (e.g., a non-transitory storage medium), an I/O interface 208, and optional trained machine learning model 210. In some embodiments, the parameter control unit 120 is coupled to one or more databases 212. The interface 208 may allow for communications with satellites 106, gateways 108, communication network 114 and/or individual irrigation devices 214 directly or via one or more of satellites 106, gateways 108, communication network 114. The interface 208 can include or be an interface to a user interface that will allow users to input usage values, such as desired battery life, satellite constellation, communication frequency and/or power levels, for example.

The control circuit 204 may comprise a processor, a microprocessor, a central processing unit (CPU), a graphics processing unit (GPU), an application-specific integrated circuit (ASIC), field programmable gate array (FPGA), discrete logic circuits and the like and may be configured to execute computer-readable instructions stored on a computer-readable storage memory 206 (which may be referred to as a non-transitory storage medium). The computer-readable storage memory 206 may comprise volatile and/or non-volatile memory and have stored upon it, a set of computer-readable instructions which, when executed by the control circuit 204, causes the parameter control unit 120 to perform its operations and functions. Trained models 210 may be stored in the memory 206 and executed by the control circuit 204. Alternatively, trained models 210 may be external and coupled to the parameter control unit 120. Trained machine learning models 210 may be any known or future model or neural network. Training may be accomplished in known or future ways, and can include supervised or unsupervised learning.

In some embodiments, the parameter control unit 120 may include a parameter control application 122 stored on the memory 206. The parameter control application 122 may conduct, when executed by the control circuit 204, various steps illustrated below, for example, conducted by the parameter control unit 120. The parameter control application 122 may be referred to generically as a set of computer-readable instructions stored, encoded, or embedded in a memory 206 (such as a non-transitory storage medium) that when executed by a control circuit 204, perform parameter control functionality.

In some embodiments, the parameter control unit 120 may test a plurality of sets of communication parameters and analyze the test results. To test multiple sets of communication parameters, the parameter control unit 120 determines a plurality of sets of communication parameters for use by the irrigation devices 214. Then, the parameter control unit may output signals to vary, with the determined plurality of sets of communication parameters, communication parameters over time for communications with irrigation devices 214 (e.g., on a component-by-component basis, or component-type by component-type basis) and receive data on power usage with the plurality of sets of the communication parameters over time by the irrigation devices 214. Data received by the parameter control unit 120 can be stored in memory 206 and/or database/s 212 for analysis. Parameter variance (i.e., the plurality of communication parameters for testing) may be manually selected/adjusted, automatically selected/adjusted per an algorithm, and/or selected/adjusted using a trained machine learning model 210 (or trained neural network). Data is analyzed in a real-world system, not a theoretical system.

There are many uses of the received power usage data. In some embodiments, received data is used to make decisions for materials, product design and usage parameters/communication parameters that will ensure battery life for at least a minimum length of time at an acceptable level of communication. In some embodiments, the real-world data is used in the selection of irrigation components, product design and usage parameters/communication parameters for other irrigation systems. In some embodiments, the parameter control unit 120 is used to determine usage parameters/communication parameters of the irrigation devices 214 to ensure a desired battery life.

In some embodiments, the parameter control unit 120 may determine a set of communication parameters for individual irrigation devices 214 and set up and/or update, with the determined set of communication parameters, communication parameters of the individual irrigation devices 214. The determination and setup/update of the communication parameters for the individual irrigation devices 214 may be on a component-by-component basis, or component-type by component-type basis. The determination of the set of the communication parameters may be based on manual selection, automatic selection per an algorithm, and/or selection using a trained machine learning model 210. In some embodiments, the determination of the set of the communication parameters may be based on the test and test results of the plurality of the sets of communication parameters discussed above.

In some embodiments, power usage data is monitored over time and the communication parameters can be further adjusted if battery life is deviating from prior estimations.

In some embodiments, the irrigation system 100 may receive an indication of a desired battery life for the irrigation devices 214 from users of the system, and the parameter control unit 120 may determine a set of communication parameters for the irrigation system component to meet the indication of the desired battery life received from the users. The irrigation system 100 may receive an indication of a desired battery life on a component-by-component basis, component-type by component-type basis by device, or irrigation zone by irrigation zone basis. In some embodiments, irrigation system 100 may receive an indication of a desired battery life for entire irrigation components. When the irrigation system receives the same indication of desired battery life for two or more irrigation system components but the battery capacities of each of the two or more irrigation system components are not the same, the parameter control application 122 may determine the different set of communication parameters for each of the two or more irrigation system components to meet the indication of desired battery life.

In some embodiments, the parameter control application 122 of the parameter control unit 120 may receive an indication of a desired battery life via the user interface of the parameter control unit 120. In some embodiments, the irrigation control device such as the irrigation controller 130, the central irrigation controller 180, and the mobile electronic device 160 having an irrigation control application may receive an indication of a desired battery life via the user interface of the irrigation control application.

Some users may prefer communications in near real-time (e.g., using short sleep cycles) and are willing to replace batteries on a more frequent basis (e.g., once per month), whereas other users may want the battery to last as long as possible (e.g., to last 1 year) and are willing to accept communications that are less real-time (e.g., using longer sleep cycles). The users may input the indication of a desired battery life based on their preference. User preferences may change over time, and the indication of the desired battery life can be updated. When the indication of the desired battery life is updated or newly input, the parameter control unit 120 can determine a new/updated set of communication parameters to result in the desired battery life of the irrigation device 214. In some embodiments, the determination of the new/updated set of communication parameter may be based on comparison of an expected battery life with current communication parameters and the indication of the desired battery life. To compare the expected battery life with the current communication parameters and the indication of the desired battery life, in some embodiments, the parameter control application 122 receives and analyze power usage data as used with communication parameters currently being used by the irrigation device and predict, based on the analyzed power usage date, an expected battery life with the communication parameters currently being used. The parameter control application 122, then, compares the expected battery life and the desired battery life and determines the new set of communication parameters for the irrigation system components based on the comparison.

In some embodiments, the parameter control application 122 may receive and analyze power usage data from the irrigation system components as used with communication parameters currently being used and in operating each irrigation system component with its operational functionality and predict an expected battery life with the communication parameters currently being used and prediction of operational functionality requirements based on the analyzed power usage date. For example, in addition to communicating with satellite transceivers, the irrigation components have different power consumption needs depending on their operational functionality. For example, a valve actuator that provides pulses of power to open and close valves uses power every time watering is to occur. Using a default or known irrigation schedule can assist the parameter control module 120 in determining the communication parameters to ensure the desired battery life. In another example, a sensor may use small amounts of power to obtain measurements. The parameter control application 122, then, compares the desired battery life and the expected battery life with the communication parameters currently being used and prediction of operational functionality requirements. Thus, in some embodiments, the communication parameters account for the intended functional power requirements of the irrigation component.

In some embodiments, the parameter control application 122 may consider temperature and/or weather conditions of the geographical area where the irrigation devices 214 are located in determining the set of communication parameters to meet the indication of the desired battery life. Some batteries may be affected by temperature, and temperature may vary the battery life. For example, some batteries may have shorter battery life in lower temperatures. Further, the irrigation devices 214 may need more battery power in cloudy areas because the irrigation devices may need to use stronger communication transmission power when it is cloudy.

In some embodiments, the parameter control application 122 may put/allocate a reserve battery capacity in determining the communication parameters. For example, the parameter control application 122 may determine the communication parameters in order for the battery to have a certain amount of remaining life, when the irrigation system components use the battery for the indicated desired battery life. For example, when the parameter control application 122 receives an indication of desired battery life of 1 year, the parameter control application 122 may determine the communication parameters to let the battery have a certain amount (e.g., 10%) of remaining battery, when the irrigation system components are used for the desired battery life (i.e., 1 year) with the determined communication parameters. In some embodiments, the parameter control application may receive an indication of a desired reserve battery capacity together with an indication of a desired battery life.

In some embodiments, the irrigation system may receive from users desired communication parameters, such as a desired communication interval/frequency, wakeup/sleep cycle for communications, satellite constellation, communication transmission power, a message length/size limit and so on.

In these embodiments, the parameter control application 122 determines the communication parameters based on communication needs and operational needs of the irrigation system components. In some embodiments, the communication needs may be determined based on the power usage of the irrigation system components according to user preferences in communications. The operational needs may be determined based on the power usage of the irrigation system components to execute an irrigation schedule.

In some embodiments, there may be regulations or laws governing power usage of the irrigation components (regardless of whether the irrigation components have full power connection or are battery powered). In such cases, the parameter control unit 120 can be provided a desired power usage level and adjust parameters to derive a set of usage parameters that will keep operation within regulations or laws.

In some embodiments, there may be regulations or laws governing the usage of the communications spectrum, including both satellite and terrestrial communications and may impose restrictions regarding the specific frequencies, data rates, radiated RF power levels, durations of transmission, transmission duty cycles or other parameters, which can be directly affected based upon user entered preferences or indirectly affected based upon the consequences of user preferences for entered schedule, desired degree or interval of reporting, time of day, desired battery life, etc. The laws and regulations governing the usage vary greatly by communications method, carrier or service provider, geographic location and legal jurisdiction. In such cases, the parameter control unit 120 can be provided a table of such limitations upon communications parameters and adjust the irrigation system parameters to derive a set of usage parameters that will keep operation within the applicable regulations or laws.

In some embodiments, when the parameter control unit 120 determines the communication parameters, the parameter control unit 120 may consider the applicable regulations and/or laws related to the power usage of each or group of irrigation system components and related to the communication functionality of the irrigation system components. When a parameter control unit receives a user indication of a desired battery life and/or communication parameters, the parameter control unit may determine remaining communication parameters for which the user did not indicate a desired value to ensure that communications of the irrigation system component comply with the communications regulations and/or laws. In some embodiments, the parameter control unit may adjust the set of communication parameters to ensure that communications of the irrigation system component comply with communications regulations and/or laws. In some embodiments, when the desired value of user indications cannot meet the related laws and regulations, the parameter control unit may send a warning to recommend changing the desired value.

The parameter control unit 120 may be implemented in a variety of ways. The parameter control unit 120 includes a parameter control application 122 which is a set of computer readable instructions or code that when executed by a control circuit of the parameter control unit 120, perform the various parameter control functions. The application 122 may be a software application installed on and executed by a general or specific purpose server, computer, mobile device, or may be firmware that is embedded in a microcontroller or other programmable device.

In some embodiments, the parameter control unit 120 is located at a location of the irrigation system components 102. In such cases, the parameter control unit 120 may be a separate device or may be a functional component of another controller, server or mobile electronic device of the irrigation system components 102. In some embodiments, the parameter control unit 120 is located outside of the location of the irrigation system components and may be provided as a service to the irrigation system components. In such embodiments, the parameter control unit 120 may be implemented in a remote computer or server coupled to the irrigation system components 102 via the network 114 and/or the gateways 108 and satellites 106. The remote computer or server provides parameter control for the user of the system of irrigation system components and/or other users of other systems of irrigation system components 102. In such cases, the parameter control unit may be considered a cloud service. And, in some embodiments, the parameter control application 122 may be at least partially implemented in specific irrigation devices 214 other than mobile electronic devices 160 and servers 150, such as irrigation controllers 130, water emitters 134, pumps 138, sensors 136, valves 140, valve actuators 142, decoders 144, and power control devices 146. In such cases, the parameter control application 122 adjusts the power usage parameters of the component to meet a given battery life and/or power usage level.

In some embodiments, the parameter control adjustments are used to meet the power limitations of the terrestrial devices that are communicating with the satellites 106, as opposed to adjustments made to meet the power limits of the satellites themselves.

Referring to FIG. 2A, an exemplary parameter control unit 120 is shown for use in the irrigation system 100 in some embodiments. The parameter control unit 120 can be implemented as any computing device such as a computer, server, controller, specific purpose or general purpose device, mobile device, fixed location, distributed computing device. The parameter control application may be stored on memory of and executed by the processor of the computing device.

The form of the parameter control unit 120 varies in different embodiments. For example, the parameter control unit may be an external or remote server running the application 122 as a service to the irrigation system components. In another example, the parameter control unit 120 may be a computing device local to the irrigation system components 102, such as a computer, local server, local controller, irrigation controller, mobile electronic device executing the application 122. In some embodiments, the parameter control unit 120 may be implemented by an irrigation controller 130 and/or a central irrigation controller 180, and the parameter control application 122 is stored on a memory of and executed by the processor of irrigation controller 130 and/or the central irrigation controller 180.

In the embodiments of FIG. 2B, at least some of the parameter control application 122 functionality is implemented at least partially in a given irrigation device 214A that contains the battery 126 or power level being evaluated (see 122A). It is understood that while not shown in FIG. 2B, the irrigation device 214A will include a corresponding control circuit and memory, and optional trained model. The application 122A can operate together with the application 122 of another parameter control unit 120, or it may operate independently from any other parameter control unit 120.

FIG. 2C further illustrates the central irrigation controller 180 communicating with the parameter control unit 120 and other irrigation devices 214A implementing the parameter control application 112A via the terrestrial network 114 and/or the gateways 108 and satellites 106.

FIG. 2D illustrates an exemplary parameter control unit 120 implemented by a mobile electronic device 160 and the parameter control application 122 integrated into an irrigation control application 222 (i.e., a mobile application) stored on memory 206 of the mobile electronic device 160 and executed by a control circuit 204 (e.g., a professor) of the mobile electronic device 160. In some embodiments, the irrigation control application 222 may perform the various parameter control functions that may be performed by the parameter control application 122 in addition to various general irrigation control functions. For example, the irrigation control application may control/adjust/test communication parameters of the irrigation system components. Although FIG. 2D only illustrates the irrigation control application 222 stored on memory 206 of the mobile electronic device 160 and executed by a control circuit 204 of the mobile electronic device 160, in some embodiments, the irrigation control application 222 may be stored on a memory of other irrigation control device (such as the irrigation controller 130 and/or the central irrigation controller 180).

Referring to FIGS. 2A-2D, the irrigation devices 214, 214A are illustrated as being battery powered (see battery 216). In such cases, the parameter control applications 122, 122A adjusts/tests the power usage parameters of the irrigation devices 214, 214A to meet a given battery life and/or power usage level. For example, the user may define or input that the battery should last X length of time (or define a given communication frequency, or power level to not be exceeded), and the parameter control application 122, 122A adjusts/tests the parameters over time to derive a set of usage/communication parameters that will meet the battery life or power level.

In some embodiments, as shown in FIGS. 2A-2D, each of the irrigation devices 214, 214A being adjusted/tested by the parameter control unit 120 and having a battery 216 may include a wireless communication transceiver (e.g., a satellite transceiver 320, see FIGS. 3A-3D) and antenna (e.g., a satellite antenna 218).

Referring now to FIG. 2D, in some embodiments, the irrigation control application 222 may display to a user satellite communication availability information via a display of the irrigation control device (e.g., the mobile electronic device 160). In some embodiments, to display the satellite communication availability information, the irrigation control application 222 may request satellite communication availability information to the satellite server 170 and receive the satellite communication availability information from the satellite server 170. The satellite communication availability information may be based on a specific geographic location. In some embodiments, the satellite communication availability information may be based on a geographic coordinate (e.g., a latitude variable, a longitude variable, and optionally an altitude variable) for a specific location. The satellite communication availability information may comprise information on when the communication satellites will be passing over the specific location, e.g., upcoming time and duration of possible satellite communications via communication satellites 106 at the specific geographic location. For example, the satellite communication availability information may include a start time, duration, and optionally an end time for upcoming available satellite communications of each satellite pass. In some embodiments, the satellite communication availability information may further comprise the maximum elevation angle of each satellite pass of upcoming available satellite communications. Generally, high elevation angle passes are advantageous for locations where they may be structured blocking the line of sight to the sky from the satellite transceiver and satellite antenna.

In some embodiments, the parameter control application 122 and/or the irrigation control application 222 may actively monitor satellite communication availabilities. Further, the parameter control application 122 and/or the irrigation control application 222 may automatically change and/or adjust a communication schedule of the irrigation system components 102 in order to communicate via alternative satellites or satellite constellations that have a better communication availability (such as a longer communication duration, more frequent communication windows, or higher max elevation angle) than a satellite via which the irrigation system component is supposed to communicate according to the communication schedule currently being used.

In some embodiments, the parameter control application 122 and/or the irrigation control application 222 may receive location information of the irrigation system components 102 that can transmit communications to the communication satellites 106 and/or receive communications from the one or more communication satellites 106. In some embodiments, the parameter control application 122 and/or the irrigation control application 222 may receive location information of the irrigation system components 102 via the one or more communication satellites 106 and/or the satellite server 170.

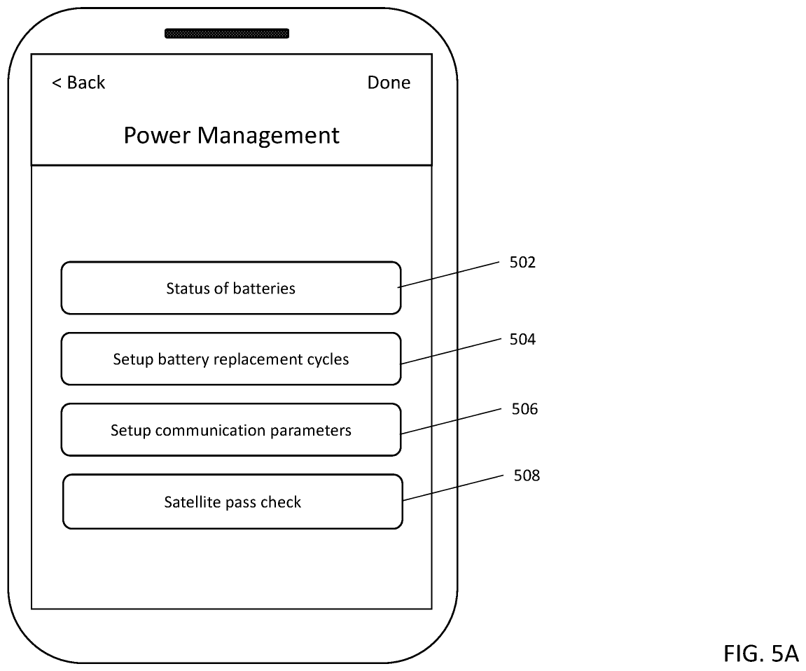

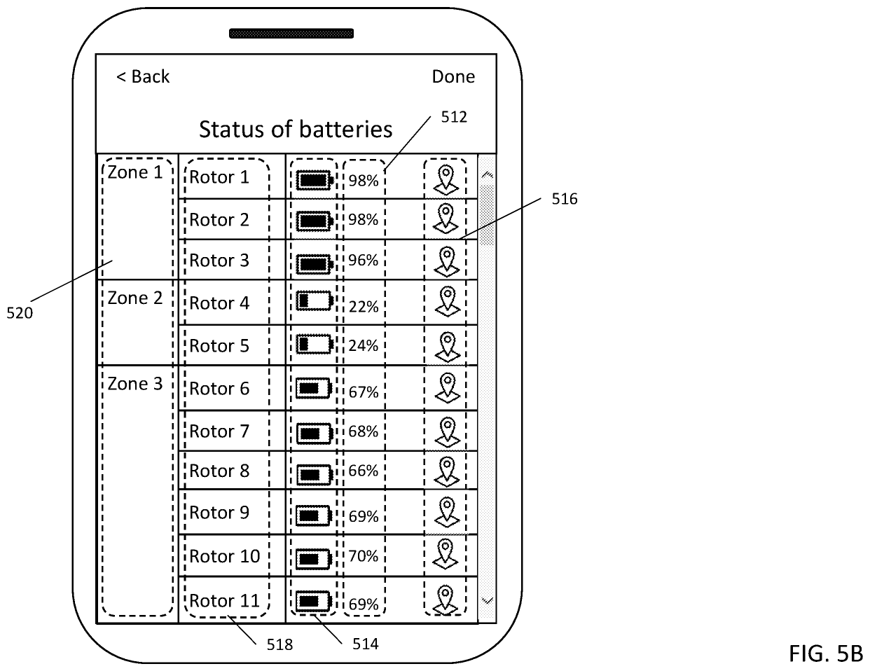

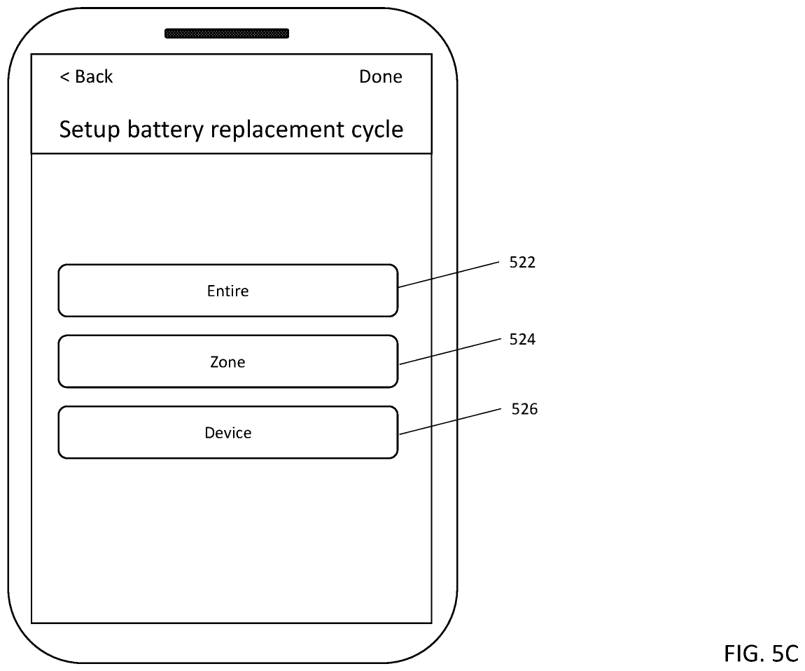

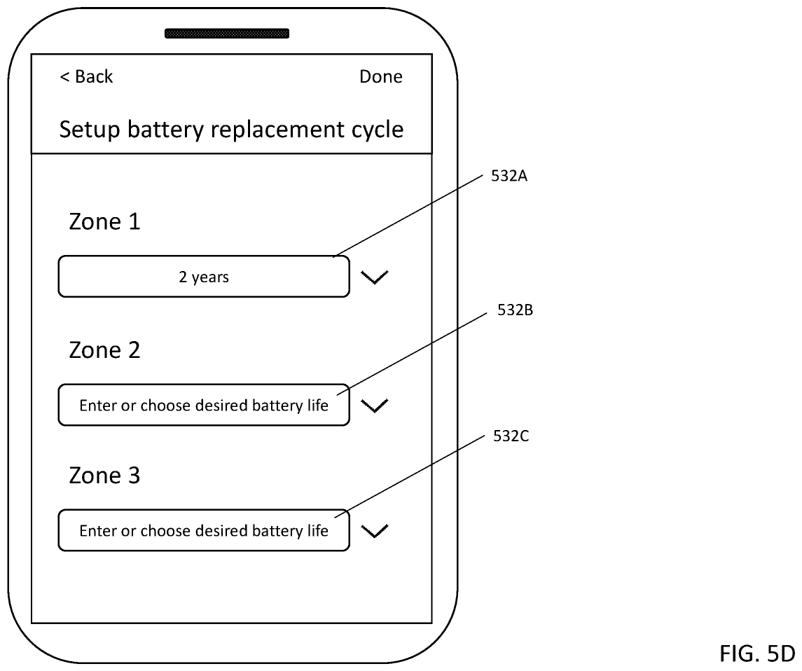

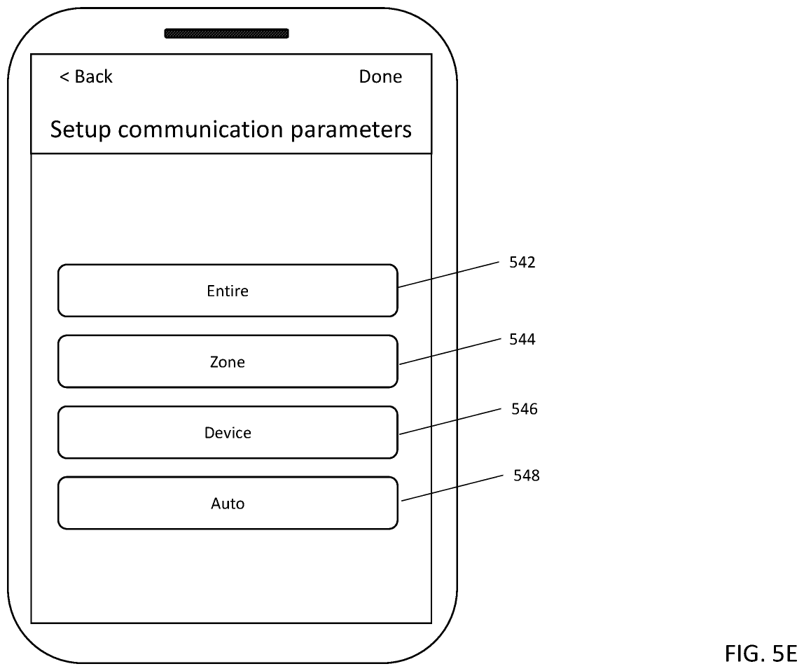

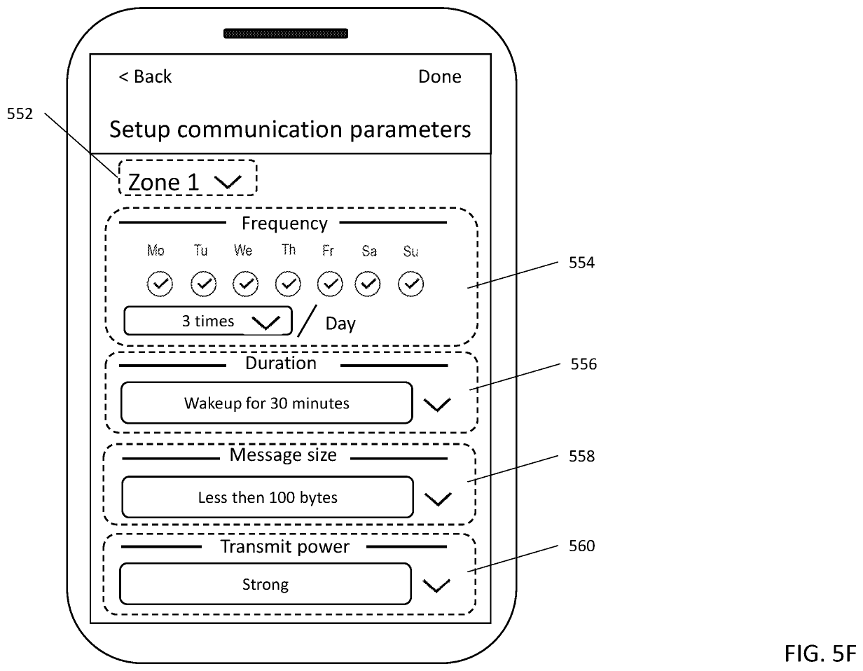

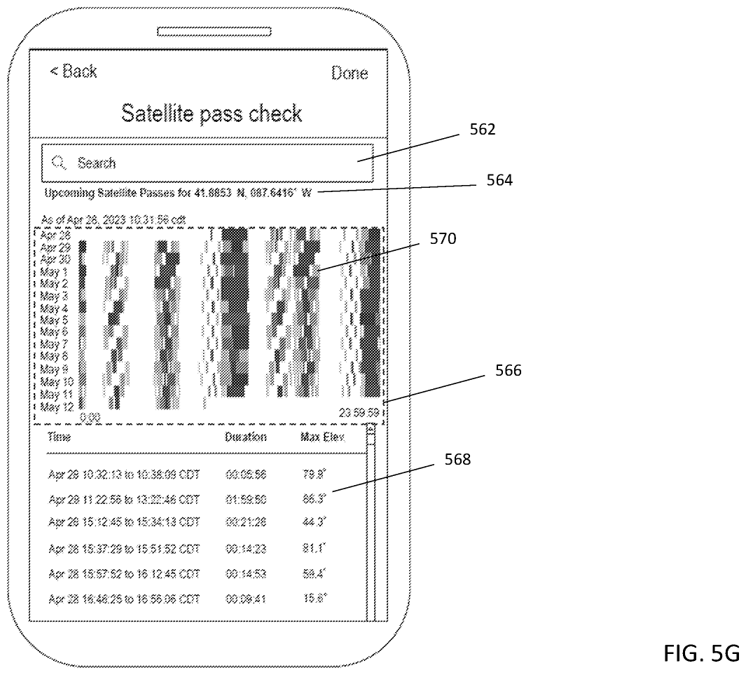

FIGS. 5A-5G illustrate example graphical user interfaces (GUIs) of an irrigation control application, such as displayed on a mobile electronic device in accordance with some embodiments.

Referring to FIG. 5A, an example GUI of the irrigation control application may include an input 502 to select an option to see the status of batteries, an input 504 to select an option to setup battery replacement cycles, an input 506 to select an option to setup communication parameters, and an input 508 to select an option to check orbiting communication satellite passes. It is understood that the inputs described herein may be any displayed and selectable icon, button, feature, element, such as found in user interfaces. The inputs are shown for display on a touch sensitive display but could also be activated by pressing a button or other physical input adjacent the display screen or clicking using a pointing device or selector button.

FIG. 5B illustrates an example GUI of the irrigation control application showing the status of battery of each irrigation system component having a battery, in accordance with some embodiments. The GUI of FIG. 5B may be displayed when a user clicks the input 502 in the GUI of FIG. 5A. The remaining battery power may be indicated with a percentage 512 of the remaining battery power against the fully charged battery power (e.g., 96%) and/or a battery icon 514 with an approximate indication of remaining battery power. The GUI of FIG. 5B further includes a map icon 516 for each irrigation system component. When a user clicks the map icon 516, the irrigation control application may provide a location of the corresponding irrigation system component. The GUI of FIG. 5B also provides a type 518 of irrigation system components and zone information 520 for each irrigation system component.

The GUI of FIG. 5C may be displayed when a user clicks the input 504 in the GUI of FIG. 5A, in accordance with some embodiments. The GUI of FIG. 5C provides users with options to select the scope of the irrigation system components to set up the battery replacement cycle. The GUI of FIG. 5C includes an input 522 to select an option to set up the battery replacement cycle for entire irrigation system components, an input 524 to select an option to set up the battery replacement cycle on a zone-by-zone basis, and an input 526 to select an option to set up the battery replacement cycle on a device-by-device basis (component-by-component basis).

FIG. 5D illustrates the GUI to set up the battery replacement cycle on a zone-by-zone basis, in accordance with some embodiments. The GUI of FIG. 5D may be provided when a user clicks the input 524 in the GUI of FIG. 5C. Users of irrigation system 100 may set up the battery replacement cycle by inputting an indication of desired battery life via input areas 532A, 532B, 532C. The indication of the desired battery life for a zone applies to all irrigation system components of the zone.

The GUI of FIG. 5E may be displayed when a user clicks the input 506 in the GUI of FIG. 5A, in accordance with some embodiments. The GUI of FIG. 5E provides users with options to select the scope of the irrigation system components to set up the communication parameters. The GUI of FIG. 5E provides an input 542 to select an option to set up the communication parameters for entire irrigation system components, an input 544 to select an option to set up the communication parameters on a zone-by-zone basis, and an input 546 to select an option to set up the communication parameters on a device-by-device basis. The GUI of FIG. 5E also provides an input 548 to select an option to automatically set up the communication parameters for irrigation system components. When a user selects the option to automatically set up the communication parameters for irrigation system components, the irrigation control application may determine and set up the communication parameters for the irrigation system components based on the desired battery life and necessary power usage for perform the operational functions.

FIG. 5F illustrates the GUI to set up the communication parameters on a zone-by-zone basis, in accordance with some embodiments. The GUI of FIG. 5F includes a zone selection section 552, a communication frequency selection section 554, a duration selection section 556, a message size selection section 558, and a transmit power selection section 560. The zone selection section 552 allows a user to select the zone for setting up the communication parameters. The communication frequency selection section 554 allows a user to set a frequency with which satellite communications will occur by selecting the days on which the satellite communications will occurs and how many times the satellite communications will occurs on the selected days. The duration selection section 556 allows a user to select the duration of wakeup time of the irrigation system components for satellite communications (e.g., wakeup for 30 minutes). The message size selection section 558 allows a user to select maximum message size to be transmitted to the communication satellites from the irrigation system components and/or be received by the irrigation system components from the communication satellites. The transmit power selection section 560 allows a user to select the weakness/strongness of the transmit power when transmitting communications to the communication satellite from the irrigation system components. Although not shown, in some embodiments, a user may select a satellite constellation for communication.

FIG. 5G illustrates the GUI showing satellite passes and satellite communication availability information, in accordance with some embodiments. The GUI of FIG. 5G may be provided when a user clicks the input 508 in the GUI of FIG. 5A. The GUI of FIG. 5G includes a location search area 562, a location indication 564, a graphical indication section 566, and a satellite pass table 568. A user may search and select a geographic location for checking the satellite passes thereover via the geographic location search area 562. In some embodiments, the entry of geographic location information may be bypassed and the use of on-board GNSS resources in the smartphone or other device running the application are used to determine geographic location for determining upcoming satellite communications windows and window intervals. The location indication 564 indicates the selected geographic locations for which the upcoming satellite communication information is provided. The graphical indication section 566 includes multiple small rectangles, each of which represents satellite passes at a specific time. The multiple small rectangles 570 may also indicate an approximate maximum elevation angle with a darkness of each rectangle. The darker rectangles represent the higher elevation angle. The satellite pass table 568 may indicate specific time (e.g., start time and end time) and duration of the upcoming satellite communications, and max elevating angle of each satellite pass. Generally, high elevation angle passes are advantageous for locations where they may be structured blocking the line of sight to the sky from the satellite transceiver and satellite antenna.

In some embodiments, one or more of the irrigation system components 102 may obtain this satellite availability data automatically and use it to automatically determine the optimal satellites to communicate with and times to communicate. For example, one or more of the central controllers, irrigation controllers, system components etc. can actively monitor satellite communication availabilities, such as shown in FIG. 5G (without necessarily displaying them to a user). And the device may automatically determine the appropriate satellite to communicate with and/or automatically change and/or adjust a communication schedule of the irrigation system component in order to communicate via one or more satellites that have a better or more convenient communication availability than a satellite via which the irrigation system component is supposed to communicate according to the communication schedule currently being used.

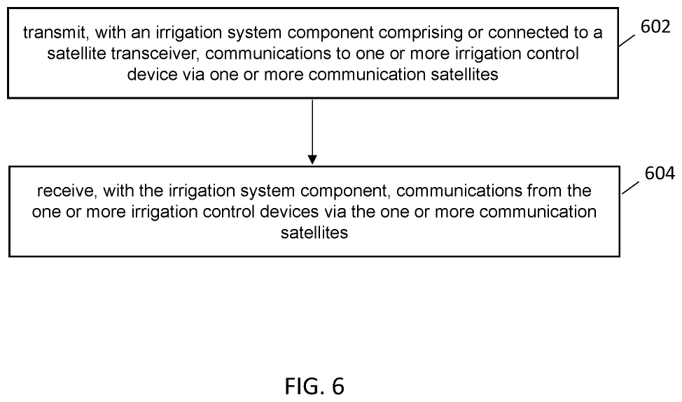

FIGS. 6-10 illustrate flow charts showing processes/methods for use in the irrigation system 100 in accordance with some embodiments. In some embodiments, the systems 100 of FIGS. 1A-1C, irrigation system components illustrated in FIGS. 2A-5G or other unit/component/device/system may implement one or more of the processes/methods of FIGS. 6-10.

Referring to FIG. 6, in step 602, one or more irrigation system components transmit communications to one or more irrigation control devices via one or more communication satellites. In step 604, one or more irrigation system components receive communications from the one or more irrigation control devices via the one or more communication satellites. In some embodiments, the one or more irrigation system components transmitting communications to the one or more irrigation control devices via the one or more communication satellites in step 602 may comprise at least one of a water emitter 134, a valve actuator 142, a valve 140, a decoder 144, a pump 138, a power control device 146, and a sensor 136. The one or more irrigation system components receiving communications from the one or more irrigation control devices via the one or more communication satellites in step 604 may comprise at least one of a water emitter 134, a valve actuator 142, a valve 140, a decoder 144, a pump 138, a power control device 146, and a sensor 136. The one or more irrigation system components receiving communications from the one or more irrigation control devices via the one or more communication satellites in step 604 may be the same as or different from the one or more irrigation system component transmitting communications to the one or more irrigation control devices via the one or more communication satellites in step 602. To enable communication using satellites, the one or more irrigation system components that communicate via one or more communication satellites comprise or are connected to a satellite transceiver and additionally a satellite antenna.

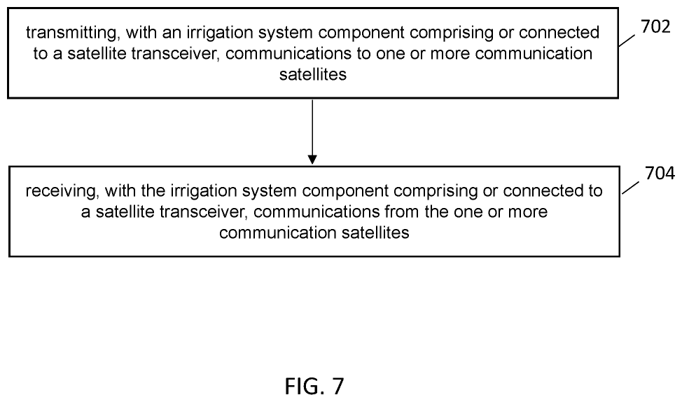

Referring to FIG. 7, in step 702, one or more irrigation system components transmit communications to one or more communication satellites. In some embodiments, the one or more irrigation system components transmitting communications to the one or more communication satellites may comprise at least one of a water emitter 134, a valve actuator 142, a valve 140, a decoder 144, a pump 138, a power control device 146, a sensor 136, and an irrigation controller operating in accordance with a schedule. In step 704, one or more irrigation system components receive communications from one or more communication satellites. In some embodiments, the one or more irrigation system components receiving communications from the one or more communication satellites may comprise at least one of a water emitter 134, a valve actuator 142, a valve 140, a decoder 144, a pump 138, a power control device, a sensor 136, and an irrigation controller 130 operating in accordance with a schedule. The one or more irrigation system components receiving communications from the one or more communication satellites in step 704 may be the same as or different from the one or more irrigation system component transmitting communications to the one or more communication satellites in step 702.

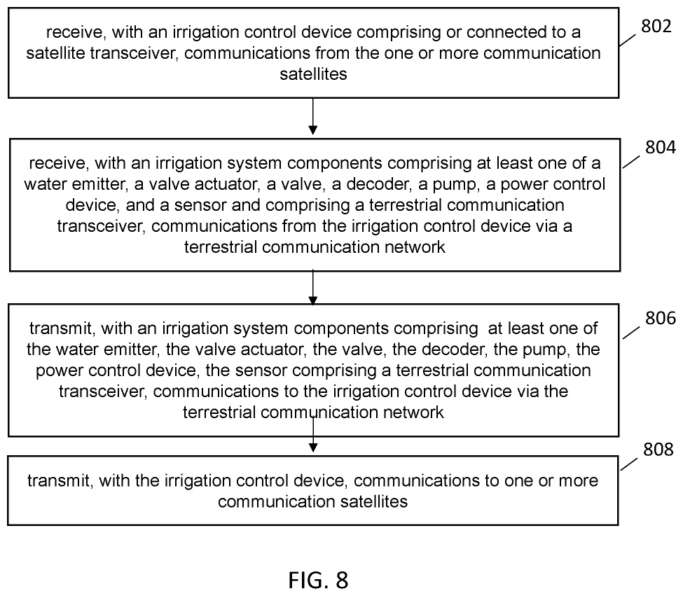

Referring to FIG. 8, in step 802, one or more irrigation control devices comprising or connected to a satellite transceiver, receive communications from the one or more communication satellites. In step 804, one or more irrigation system components functioning as at least one of a water emitter 134, a valve actuator 142, a valve 140, a decoder 144, a power control device 146, a pump 138, and a sensor 136 comprise a terrestrial communication transceiver and receive communications from the one or more irrigation control devices via a terrestrial communication network. In step 806, one or more irrigation system components functioning as at least one of a water emitter 134, a valve actuator 142, a valve 140, a decoder 144, a pump 138, a power control device 146, and a sensor 136 comprise a terrestrial communication transceiver and receive communications from the one or more irrigation control devices via the terrestrial communication network. The one or more irrigation system components receiving communications from the one or more irrigation control devices in step 806 may be the same as or the different from the one or more irrigation system components transmitting communications to the one or more irrigation control devices in step 804. In step 808, the one or more irrigation control devices transmit communications to one or more communication satellites. In some embodiments, the one or more irrigation control devices communicating with the one or more communication satellites comprise a battery and are battery powered.

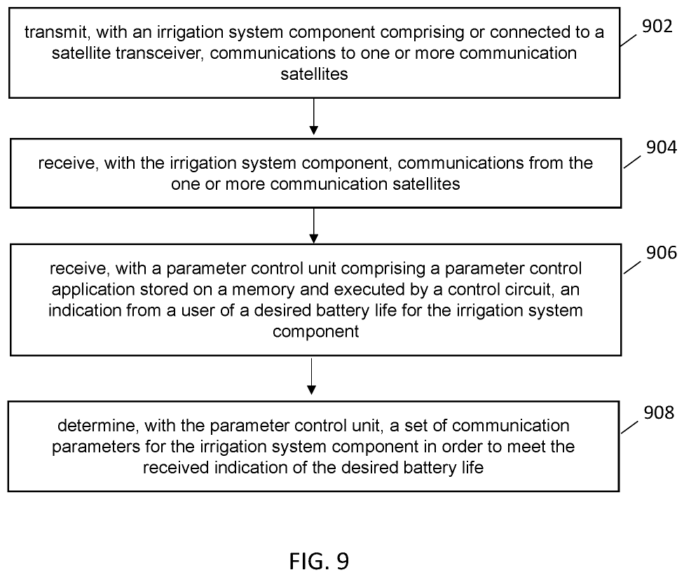

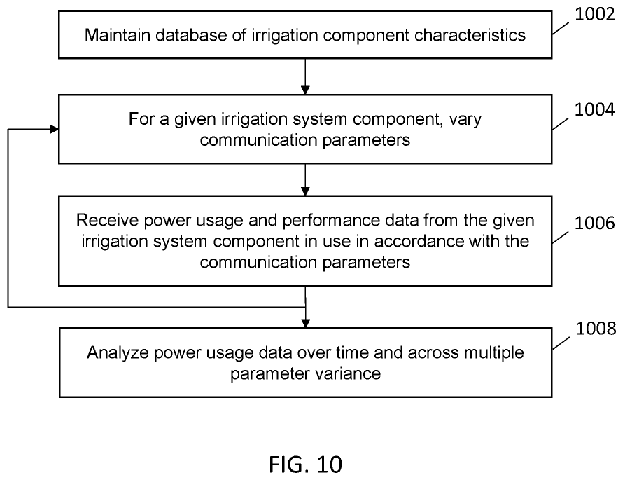

FIGS. 9 and 10 illustrate flow diagrams showing processes/methods for use in the irrigation system with parameter control unit. In some embodiments, the various parameter control units 120 of FIGS. 2A-2D and/or the various systems 100 of FIGS. 1A-1C or other unit/system implements this process. For example, the execution of code by the control circuit 204 and/or the trained model 210 perform the processes/methods of FIGS. 9-10.

Referring to FIG. 9, in step 902, one or more irrigation system components comprising or connected to a satellite transceiver transmit communications to one or more communication satellites. In step 904, one or more irrigation system components comprising or connected to a satellite transceiver receive communications from the one or more communication satellites. In the processes/methods of FIG. 9, one or more irrigation system components transmitting communications to one or more orbiting communication satellites and/or receiving communications from the one or more orbiting communication satellites may comprise a battery and be battery powered. In step 906, the parameter control unit 120 comprising a parameter control application stored on a memory and executed by a control circuit receives an indication from a user of a desired battery life for the one or more irrigation system components communicating using communication satellites. In step 908, the parameter control unit determines a set of communication parameters for the one or more irrigation system components communicating using communication satellites in order to meet the received indication of the desired battery life. In some embodiments, the parameter control unit considers communication needs, operational needs of the irrigation system components, and/or environmental considerations. For example, in some embodiments, the operational needs of irrigation components may be determined by accessing scheduling or other data indicating when power is consumed and how often when the component is operating per its intended function. And environmental data or conditions may be accessed that is specific to the location and/or time or year/season and considered in the determination of the communication parameters to meet the desired battery life. The environmental data or conditions may be obtained at the location of the irrigation components or may be data representative of the location of the irrigation system component. That is, in some cases, it may not be practical to obtain environment data at the precise location, such as environment data is obtained for the area or another area known to have similar environment conditions.

Referring now to FIG. 10, in some embodiments, the process starts by generating and maintaining a database of irrigation component (or device) characteristics as installed in the field for use (Step 1002). This database (e.g., database 212) can include information about the component/device such as: component type, model, serial number/identification, component functionality, product age, installation factors and location (above ground, below grade, known interference/obstructions), battery type (rechargeable or not, chemistry, capacity, form, manufacturer specifications), for example. The database can include desired or expected minimum communication and/or life performance, such as intended communication frequency, communication bands, satellite constellation, battery life, and/or power levels not to be exceeded, for example. The database can include current parameter settings for parameters such as communication bands and power, satellite constellation, polling frequency, and message sizes. Further, the database can include any stored or received power consumption levels or performance indicators (such as bit error rates (BER), RSSfeedback, SNR or number of missed packets or missed communications windows) corresponding to the parameters that may be received from various sources (such as from the irrigation components and the satellites).

Next, for a given component or device, the communication parameters are varied (Step 1004). For example, the parameter control unit determines a new or next set of parameters that the irrigation component should use and communicate those parameters to the irrigation component and any other device/s needing such parameters (or alternatively, pass the parameters to the communication module of the component if the component itself implements the application). For example, the communication parameters may define a specific polling frequency, a specific message length, a specific wake/sleep cycle, satellite constellation, transmit power, and so on. The irrigation component will then operate per those parameters until otherwise instructed. The irrigation component will monitor and/or sense its power consumption over time and this information and any other relevant performance data (such as error rates, missed packets, signal to noise ratio) will be reported back to the parameter control unit (or maintained by the component if the component itself implements the application).

The parameter control unit receives power usage and performance data from the given irrigation system component in use in accordance with the communication parameters (Step 1006). Further, performance data may be received from other sources, such as from the satellites 106. The database is updated with the data.

This process continues back to Step 1004 in which the communication parameters are varied again. The time between parameter changes may be set or varied as well but should ensure usage for a length of time representative of the power usage given those parameters.

While the parameters are changed or after a desired number of parameter permutations, the power usage data is analyzed over time (Step 1008). Such analysis can inform of future parameter changes needed, and/or a set of sets of parameters that will result in operation lasting at least a preferred period of time before the battery needs to be rechanged or replaced, will result in a desired communication frequency and battery life, and/or will result in meeting required power limits of the irrigation system components. Machine learning models may be used to analyze the power consumption data. In some embodiments, operational power usage requirements are obtained and stored in the database, e.g., by accessing planned usage schedules depending on the device type and programming. And further, in some embodiments, environmental factors may be obtained and stored in the database for consideration.

FIG. 11 illustrates an exemplary distributed control irrigation system 1100 using satellite communications in accordance with some embodiments. An irrigation system 1102 in some embodiments includes a central controller 180 in a first hierarchy layer with a plurality of irrigation controllers 130 in a second hierarchy layer. The central controller 180 can be any computer-based controller or other server-based or cloud-based server having central irrigation control functionality. The controllers 130 can be any irrigation control devices such as those described herein such as intermediary computer controllers, computers with control software, dedicated controllers, field controllers, handheld controllers, and mobile electronic devices 160 with control software (irrigation control applications or apps). The controllers 130 generally fall under the central controller 180 and are controlled or directed by the central controller 180. Also shown are various irrigation components (shown as irrigation devices 214) in a third hierarchy layer. These devices are controlled or directed by the various controllers 130, or are assigned to and provide data to the upper layers or other components in the layer (e.g., sensors). Depending on the system, the communications links between the devices of the different layers may be wired and/or wireless. Wireless communications may be via terrestrial networks as is known. However, in accordance with several embodiments, communications may be via satellite communications using satellites 106 with any devices having a satellite transceiver. It is noted that terrestrial networks are not shown since this illustration is intended to show the flexibility and addition of satellite communications to route signals, messages and communications between one or more devices within a hierarchy layer or across hierarchy layers. Irrigation control functionality can be contained in certain devices or may be distributed across multiple devices in different hierarchy layers.

FIG. 11 also shows a second irrigation system 1104, which could be any other irrigation system and could be similarly set up as system 1102. For example, the central controller 180 may be a cloud-based or server-based central controller that services different irrigation systems managed/owned by different users/entities. There may be many other systems, and these are represented by second system 1104.

This specification describes various embodiments and variations thereof relating to irrigation systems using satellite communications. In some embodiments, an irrigation system comprises an irrigation system component comprising or connected to a satellite transceiver configured to transmit communications to one or more irrigation control devices and/or receive communications from the one or more irrigation control devices via one or more communication satellites, wherein the irrigation system component comprises at least one of a water emitter, a valve actuator, a valve, a decoder, a pump, a power control device, and a sensor.

In some embodiments, an irrigation system comprises a plurality of irrigation system components each comprising: an irrigation control device comprising or connected to a satellite transceiver configured to transmit communications to one or more communication satellites and/or receive communications from the one or more communication satellites, wherein the irrigation control device comprises a battery and is battery powered; and at least one of a water emitter, a valve actuator, a valve, a decoder, a pump, a power control device, and a sensor; wherein the at least one of the water emitter, the valve actuator, the valve, the decoder, the pump, the power control device, and the sensor comprises a terrestrial communication transceiver and is configured to transmit the communications to the irrigation control device and/or receive the communications from the irrigation control device via a terrestrial communication network.

In some embodiments, an irrigation system comprises an irrigation system component comprising or connected to a satellite transceiver configured to transmit communications to one or more communication satellites and/or receive communications from the one or more communication satellites, wherein the irrigation system component comprises a battery and is battery powered; wherein the irrigation system component comprises at least one of a water emitter, a valve actuator, a valve, a decoder, a pump, a power control device, a sensor, and an irrigation controller operating in accordance with a schedule.

In some embodiments, an irrigation system comprises an irrigation system component comprising or connected to a satellite transceiver configured to transmit communications to one or more communication satellites and/or receive communications from the one or more communication satellites, wherein the irrigation system component comprises a battery and is battery powered; and a parameter control unit comprising a parameter control application stored on a memory and, when executed by a control circuit, configured to: receive an indication from a user of a desired battery life for the irrigation system component; determine a set of communication parameters for the irrigation system component in order to meet the received indication of the desired battery life.

In some embodiments, a method for use in an irrigation system, the method comprising the steps of: transmitting, with an irrigation system component comprising or connected to a satellite transceiver, communications to one or more irrigation control devices via one or more communication satellites; and/or receiving, with the irrigation system component, communications from the one or more irrigation control devices via the one or more communication satellites, wherein the irrigation system component comprises at least one of a water emitter, a valve actuator, a valve, a decoder, a pump, a power control device, and a sensor

In some embodiments, a method for use in an irrigation system, the method comprising the steps of: receiving, with one or more irrigation control devices each comprising or connected to a satellite transceiver, communications from one or more communication satellites; receiving, with an irrigation system component comprising at least one of a water emitter, a valve actuator, a valve, a decoder, a pump, a power control device, and a sensor and comprising a terrestrial communication transceiver, communications from the one or more irrigation control devices via a terrestrial communication network; transmitting, with the irrigation system component comprising at least one of the water emitter, the valve actuator, the valve, the decoder, the pump, the power control device, the sensor comprising the terrestrial communication transceiver, communications to the one or more irrigation control devices via the terrestrial communication network; and transmitting, with the one or more irrigation control devices, communications to the one or more communication satellites, wherein the one or more irrigation control devices each comprises a battery and is battery powered.

In some embodiments, a method for use in an irrigation system, the method comprising the steps of: transmitting, with an irrigation system component comprising or connected to a satellite transceiver, communications to one or more communication satellites; and/or receiving, with the irrigation system component comprising or connected to the satellite transceiver, communications from the one or more communication satellites, wherein the irrigation system component comprises a battery and is battery powered, and the irrigation system component comprises at least one of a water emitter, a valve actuator, a valve, a decoder, a pump, a power control device, a sensor, and an irrigation controller operating in accordance with a schedule.

In some embodiments, a method for use in an irrigation system, the method comprising the steps of: transmitting, with an irrigation system component comprising or connected to a satellite transceiver, communications to one or more communication satellites, wherein the irrigation system component comprises a battery and is battery powered; receiving, with the irrigation system component, communications from the one or more communication satellites; receiving, with a parameter control unit comprising a parameter control application stored on a memory and executed by a control circuit, an indication from a user of a desired battery life for the irrigation system component; and determining, with the parameter control unit, a set of communication parameters for the irrigation system component in order to meet the received indication of the desired battery life.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. An irrigation system comprising:
an irrigation system component comprising or connected to a satellite transceiver configured to transmit communications to one or more irrigation control devices and/or receive communications from the one or more irrigation control devices via one or more communication satellites,
wherein the irrigation system component comprises at least one of a water emitter, a valve actuator, a valve, a decoder, a pump, a power control device, and a sensor.

2. The irrigation system of claim 1 wherein the irrigation system component comprises a battery and is battery powered.

3. The irrigation system of claim 1 wherein the one or more irrigation control devices comprise or are connected to a satellite transceiver.

4. The irrigation system of claim 3 wherein the one or more irrigation control devices operate in accordance with a schedule.

5. The irrigation system of claim 3 wherein the one or more irrigation control devices comprise at least one of an irrigation controller, a central irrigation controller, and a mobile electronic device having an irrigation control application installed thereon.

6. The irrigation system of claim 1, further comprising a parameter control unit configured to control communication parameters of the irrigation system component.

7. The irrigation system of claim 1, wherein the irrigation system component is configured to directly communicate with the one or more communication satellites.

8. The irrigation system of claim 1, the irrigation system component is configured to transmit communications to a satellite server and/or receive communications from the satellite server via the one or more communication satellites.

9. The irrigation system of claim 1, the one or more irrigation control devices are configured to transmit communications to a satellite server and/or receive communications from the satellite server via the one or more communication satellites.

10. The irrigation system of claim 1, the one or more irrigation control devices are configured to communicate, via a terrestrial network, with a satellite server to deliver, via the satellite server and the one or more communication satellites, messages to the irrigation system component.

11. The irrigation system of claim 1, wherein the one or more communication satellites comprise communication satellites that are configured for satellite-to-satellite communications.

12. The irrigation system of claim 1, wherein the one or more irrigation control devices comprise an irrigation control application stored on a memory of the one or more irrigation control devices and, when executed by a processor of the one or more irrigation control devices, the irrigation control application is configured to:
request satellite communication availability information from a satellite server; and
receive the satellite communication availability information from the satellite server.

13. The irrigation system of claim 1, wherein the one or more irrigation control devices comprise an irrigation control application stored on a memory of the one or more irrigation control devices and, when executed by a processor of the one or more irrigation control devices, the irrigation control application is configured to receive, from the one or more communication satellites, locations of the irrigation system component.

14. The irrigation system of claim 1 further comprising an irrigation control application stored on a memory of a mobile electronic device and, when executed by a processor of the mobile electronic device, the irrigation control application is configured to control communication parameters of the irrigation system component.

15. The irrigation system of claim 1 wherein the irrigation system component comprises a battery and is battery powered, and wherein the one or more irrigation control devices are configured to:
receive an indication from a user of a desired battery life for the irrigation system component.

16. The irrigation system of claim 1 further comprising a parameter control unit configured to determine a set of communication parameters for the irrigation system component in order to meet an indication of a desired battery life from a user.

17. The irrigation system of claim 1, wherein the irrigation system component is a component with one of the water emitter, the valve actuator, the valve, the decoder, the pump, the power control device, and the sensor, or a component with any one or more of or any combination of the water emitter, the valve actuator, the valve, the decoder, the pump, the power control device, and the sensor.

18. The irrigation system of claim 1, wherein the irrigation system component is further configured to communicate via one or more alternative communications that exclude satellite communications, and wherein a communication that has been attempted to transmit via satellite communications is automatically redirected via one of the one or more alternative communications in an event that any one or more following trigger conditions are detected:
communications via a satellite link are unavailable;
the communications attempted to transmit via the satellite link is unsuccessful in excess of a predetermined period or number of attempts; and
a malfunction or fault is detected in the satellite transceiver.

19. The irrigation system of claim 1, wherein the one or more irrigation control devices are configured to communicate with the one or more communication satellites; and
the one or more irrigation control devices are configured to operate in accordance with a default schedule stored in memory of the one or more irrigation control devices in an event that any one or more following trigger conditions are detected:
communications via a satellite link are unavailable;
the communications attempted to transmit via the satellite link is unsuccessful in excess of a predetermined period or number of attempts; and
a malfunction or fault is detected in the satellite transceiver.

20. The irrigation system of claim 1 comprising multiple irrigation control devices and multiple irrigation system components comprising at least one of the water emitter, the valve actuator, the valve, the decoder, the pump, the power control device, and the sensor,
wherein the multiple irrigation control devices are interconnected in a hierarchy to distribute the multiple irrigation system components across the multiple irrigation control devices.

21. The irrigation system of claim 1, wherein the one or more irrigation control devices comprise an irrigation control application stored on a memory of the one or more irrigation control devices and, when executed by a processor of the one or more irrigation control devices, the irrigation control application is configured to:
actively monitor satellite communication availabilities; and
automatically change and/or adjust a communication schedule of the irrigation system component in order to communicate via one or more alternative satellites that have better communication availability than a satellite via which the irrigation system component is supposed to communicate according to the communication schedule currently being used.

22. The irrigation system of claim 1, wherein the irrigation system component comprising the sensor, the sensor comprising or connected to the satellite transceiver, and the sensor is configured to:
communicate with the one or more communication satellites; and
share, via the one or more communication satellites, sensor data to the one or more irrigation control devices and/or an irrigation control device of another irrigation system used by another user.

23. An irrigation system comprising:
an irrigation system component comprising or connected to a satellite transceiver configured to transmit communications to one or more communication satellites and/or receive communications from the one or more communication satellites, wherein the irrigation system component comprises a battery and is battery powered;
wherein the irrigation system component comprises at least one of a water emitter, a valve actuator, a valve, a decoder, a pump, a power control device, a sensor, and an irrigation controller operating in accordance with a schedule.

24. The irrigation system of claim 23 further comprising a parameter control unit, wherein the parameter control unit comprises a parameter control application stored on a memory and, when executed by a control circuit, configured to:
determine a plurality of sets of communication parameters for use by the irrigation system component;
output signaling to vary, with the plurality of sets of communication parameters, the communication parameters of the irrigation system component over time;
receive power usage data from the irrigation system component over time as used with the plurality of sets of communication parameters; and
analyze the power usage data.

25. The irrigation system of claim 23, further comprising a parameter control unit, wherein the parameter control unit comprises a parameter control application stored on a memory and, when executed by a control circuit, configured to:
determine a set of communication parameters for the irrigation system component; and
set up or update, with the determined set of communication parameters, communication parameters of the irrigation system component.

26. An irrigation system comprising:
an irrigation system component comprising or connected to a satellite transceiver configured to transmit communications to one or more communication satellites and/or receive communications from the one or more communication satellites, wherein the irrigation system component comprises a battery and is battery powered; and
a parameter control unit comprising a parameter control application stored on a memory and, when executed by a control circuit, configured to:
receive an indication from a user of a desired battery life for the irrigation system component; and
determine a set of communication parameters for the irrigation system component in order to meet the received indication of the desired battery life.
